(19) United States
(12) Patent Application Publication
(10) Pub. No.: US 2015/0120319 A1
(43) Pub. Date: Apr. 30, 2015

(54) System and Method for Improving Medical Diagnoses and Treatments

(71) Applicants: James Wilson, Mayaguez, PR (US); Zeno L. Charles-Marcel, Wildwood, GA (US); Dona Cooper-Dockery, McAllen, TX (US)

(72) Inventors: James Wilson, Mayaguez, PR (US); Zeno L. Charles-Marcel, Wildwood, GA (US); Dona Cooper-Dockery, McAllen, TX (US)

(21) Appl. No.: 14/529,588

(22) Filed: Oct. 31, 2014

Related U.S. Application Data
(60) Provisional application No. 61/898,261, filed on Oct. 31, 2013.

(51) Int. Cl. G06F 19/00

(52) U.S. Cl. CPC G06F 19/345
USPC 705/2

(57) ABSTRACT

Disclosed herein are systems and methods for improving medical diagnoses and treatments, whether preventive or for a current condition, by healthcare professionals. The disclosed principles may be implemented in a computer-based system across a computer network to assist healthcare professionals in evaluating and treating patients. The disclosed principles provide a universal patient questionnaire that is dynamic with regard to the responses provided during patient interviews. In addition to standardized questions for all patients, the dynamic questionnaire adjusts its inquiries to each patient based on each patient's responses. The dynamic questionnaire gathers at least the minimum information needed to provide an accurate diagnosis for each patient. This ensure physicians that “best practices” for each set of medical facts is followed. It also creates accuracy and uniformity in physician diagnoses and treatment, especially for preventative care situations.

### RELATED APPLICATION

This disclosure is a non-provisional conversion of, and thus claims priority to, U.S. Provisional Patent Application No. 61/898,261, filed Oct. 31, 2014, the entirety of which is incorporated herein by reference in its entirety for all purposes.

### TECHNICAL FIELD

The present invention relates in general to the medical diagnosis and treatment of medical conditions by physicians, and more particularly to systems and methods for improving the accuracy and consistency of medical diagnoses and treatments.

### BACKGROUND

In modern medical practice, a physician's role is to diagnose a patient's condition, and based on that diagnosis, prescribe a proper treatment plan for the patient to follow. However, several issues with this conventional process often arise. Specifically, physicians continually struggle to determine and to adhere to “best practices” in prevention and treatment for patients. Additionally, physicians also often struggle to adhere to strict and often-changing evidence-based guidelines as interpreted by established and evolving medical institutions or agencies, such as those maintained by Medicare or even private insurance companies. In addition to adhering to such best practices standards, physicians also struggle to cut costs while improving revenues and increasing patient satisfaction. Furthermore, physicians often miss qualifying screening or other procedures that not only assist patient diagnosis and treatment, but may be required for coverage of certain treatment options by agencies or insurance companies, and which may also be additional sources of revenue for healthcare providers.

In addition to the struggles discussed above, in current medical practice physicians tend to be more reactive to patient conditions, as opposed to being more focused on preventative patient care. Exacerbating such current practices is a medical community that financially rewards physicians for the treatment of patients after illness, rather than for increasing preventive healthcare measures focused on preventing illness in the first place. However, modern healthcare reform movements continue to focus on preventative healthcare, and thus evolving modern practice will focus on rewarding physicians more for their preventative successes. Importantly, however, for a preventative plan for a patient to be successful, consistent and accurate assessment of a patient's medical condition or medical issues is essential. Unfortunately, physicians often, whether by oversight or inexperience, do not consistently and thoroughly elicit patient information in order to develop a proper diagnosis or treatment plan for each patient. Moreover, consistency and accuracy in both diagnosis and treatment selections is also lacking when viewed from physician to physician, even for patients similarly situated.

Accordingly, what is needed in the art is a system and method that assists physicians in patient evaluation and developing treatment plans such that physicians employing the system or method are assured of providing accurate and consistent patient care in accordance with the best practices in each particular medical field. Such a system and method should additionally be capable of assisting physicians in complying with medical coverage guidelines, such as Medicare guidelines and the like. The disclosed principles provide such systems and methods, as discussed in detail below.

### SUMMARY

Disclosed herein are systems and methods for improving medical diagnoses and treatments, whether preventive or for a current illness or condition, by healthcare professionals. More specifically, the disclosed principles may be implemented in a computer-based system, for example, across a computer network, that employs machine learning to assist healthcare professionals in the evaluation and treatment of their patients by providing standardization in both diagnosis and treatment of similarly situated patients, regardless of the physician. In advantageous embodiments, the disclosed principles provide for a universal patient questionnaire that is dynamic with regard to the responses provided during patient interviews. In addition to providing standardized questions for all potential patients, the dynamic questionnaire also adjusts its inquiries to each particular patient based on each patient's responses. Importantly, the dynamic questionnaire is configured to gather at least the minimum information needed to provide an accurate diagnosis for each particular patient. The machine learning process then “learns” from the information provided on numerous patients by numerous physicians, and compiles the information for providing to physician-users of the system. All of these advantages, as well as others disclosed herein, are provided by the machine learning process of the disclosed principles, which compiles not only patient information, but also treatment successes and failures, as well as physician feedback, to provide standardization back to all physicians employing the system. As used herein, the term “machine learning” refers to any technique employed by a computer or similar device, either now existing or later developed, understood and practiced by those skilled in the relevant technology field. Accordingly, one skilled in the relevant technology field would understand what machine learning technology, and how best to implement it, may be used to implement the machine learning provided by the disclosed principles. In this regard, the disclosed principles ensure physicians that “best practices” for each particular set of medical facts is followed. This helps create more accuracy and uniformity in both physician diagnoses and treatment, especially for preventative care situations, when patients are similarly situated. Moreover, since the dynamic questionnaire is provided using the disclosed system, a medical assistant or other personnel can administer the questionnaire so that the physician is not required to spend his or her time gathering information from the patient, or ensuring that sufficient information has been gathered. Additionally, the patient can fill out a paper or electronic version of the questionnaire at home or in the waiting room of their healthcare provider, as discussed in further detail below. This reduces the amount of time the medical office will need to spend acquiring the data.

By gathering at least the minimum necessary medical information, the disclosed principles then further provide possible treatment options for the queried patient's condition, symptoms, etc. In this respect, the disclosed principles again ensure that best practices are followed for the potential treatment options or plans available to each particular patient. Moreover, when multiple potential treatment options are available for a given set of patient circumstances, the disclosed system may also inform the physician on past results for each of those options, or even what accepted and/or best practices may be, which provides the physician more information with which to make the treatment selection. Still further, the disclosed system can receive optional physician feedback to the system, which can then be used to update system data and better inform all users of the system. More specifically, in addition to the system storing a patient's information gathered from the dynamic questionnaire and the potential treatment options offered for each patient, a system as disclosed herein may also store the particular treatment option selected by the physician. The physician may then provide the results of that treatment on the patient to the system, and that data may further be aggregated with data in the system to further inform other users of the system on the likelihood of success for that treatment option on a patient having a given set of symptoms or a certain medical condition, issue, etc. In addition to specific results of a selected treatment option, the system can also support physician feedback on the treatment option. That feedback is also stored in the system, and may be used to assist the system in later determination of potential treatment options for the same set of medical facts and/or may be presented to another physician faced with multiple treatment options to assist that physician in make his selection of a treatment option to try.

In sum, a system or method implemented in accordance with the disclosed principles provides for the standardization of medical diagnoses and treatment options for those diagnoses, as well as providing quality assurance in both the diagnosis and treatment of patients among a single healthcare provider or across multiple providers with similarly situated patients. In addition, the disclosed principles can assist medical practitioners comply with predetermined medical guidelines, such as those required by Medicare, for initial preventive exams and annual preventive visits, as well as for the diagnoses and treatment of currently developing conditions, current illnesses, and other medical situations. Additionally, the disclosed principles help physicians become more efficient in complying with such predetermined guidelines for medical services with less overall cost, better use of physician face time with patients as well as overall physician time, improved patient satisfaction, and less reworking or denial of payment request from private or public reimbursement organizations. Furthermore, the disclosed system provides a dynamic database that ensures best practices for a given patient's needs, as well as immediate access to information on treatment options, current medical practices in the community, and treatment successes for similarly situated patients using machine learning principles that compile information from multiple sources, and pushes information based on best practices for a given set of medical facts back to each physician via system terminal. Such features provided by the disclosed principles provide technical solutions to existing problems of consistent diagnoses and treatment options for multiple patients that are similarly situated regardless of geographic location or education or experience of each patients' physician. Specifically, there is currently no way to provide such consistency across all physicians seeing similarly situated patients. Similarly, the disclosed principles provide technical solutions to the existing problem of consistency in recognition and compliance with eligibility and coverage guidelines with governmental agencies rules, such as CMS, insurance companies, and any other entity having eligibility or coverage guidelines for similarly situated patients. Importantly, although the disclosed principles may employ components and technologies such as computer networks and servers, informational data stores, client terminals, and computer-based learning machines, the disclosed principles implement these components and technologies in a uniquely functioning system or computer-implemented process that has not existed in the prior art in order to provide these technical solutions to such existing problems.

### BRIEF DESCRIPTION OF THE DRAWINGS

FIG. 1 illustrates a flow diagram demonstrating exemplary activities that may take place within a system or method implemented in accordance with the disclosed principles; and

FIG. 2 illustrates an exemplary embodiment of a computer-implemented system in accordance with the disclosed principles.

### DETAILED DESCRIPTION

As introduced above, a system or method implemented in accordance with the disclosed principles is designed to promote physician compliance with “best practices” and evidence-based guidelines, without sacrificing the physician's preferred approach to taking care of their patients or their ability to give them the individualized care they deserve. The disclosed principles accomplish this by addressing two of the most common, but avoidable, causes of physician non-compliance: physician awareness and physician attitude. More specifically, physician awareness involves a physician's familiarity with a given patient's condition or symptoms, the physician's grasp of the most current medical knowledge, and a physician's unintended oversight of a patient's symptoms or treatment needs. Physician attitude involves the issues physicians face from the overburden of regulations, disagreement with third-party (e.g., agencies, etc.) intrusions into the diagnosis and treatment process, feeling of victimization, and little expectation of positive outcomes from selected treatment options. The disclosed system and process also addresses patient adherence and poor compliance by providing the physician and his/her office staff with the tools to properly evaluate patient adherence to the plan of care, and the educational material and processes best suited to encourage patient cooperation, collaboration, and active management of their health issues.

A system or method designed and implemented in accordance with the disclosed principles is rules based. Specifically, the disclosed principles are guided by a set of rules that begin with, and are updated using machine learning to stay consistent with, best practices determined by physician practices and feedback as well as known medical information, and evidence-based guidelines, such as guidelines or requirements associated with Medicare or a similar health-based agency or organization. In all embodiments, such best practices rules are implemented using a standardized list of questions asked of a patient in order to solicit information regarding their medical condition. The standardized questions are administered to any patient that visits a healthcare provider, such as a general practice physician. Additionally, the answers provided to the standardized list of questions are further used to diagnose the patient's condition, and thereby determine potential treatment options for that particular condition.

Although the list of potential questions to be asked of a patient are a standard list, the list of questions that are actually presented to any particular patient are dynamic in their selection by the disclosed system. More specifically, as personnel associated with a healthcare provider present the questions to a patient, or even in those embodiments where a patient simply reads and answers the questions via a client terminal or portal themselves, the responses provided by that patient will dynamically alter the next questions presented to the patient. For example, if during the questioning the patient's responses indicate that their medical situation involves a pain in their abdomen, then the list of questions next asked of the patient will be selected to investigate the indicated pain, as opposed to having later questions inquire about a different part of the patient's body unrelated to the abdomen. In a preventative care example, the response to some questions may begin to indicate a likelihood the patient may develop a condition over time, such as diabetes, and thus the disclosed system can continue with a line of questioning configured to help assess the patient's risk for that condition. However, although the list of questions is dynamic as such, the disclosed principles provide that the dynamically changing line of questioning remains standardized for the particular focus that the new questions are following.

Stated another way, for all patients whose responses to certain questions cause the line of later questions to continue to inquire about a particular medical condition or symptoms, the later questions would still remain standard for all similarly situated patients. As a result, a system or method implemented in accordance with the disclosed principles provides for consistent best practices to be applied to all similarly situated patients, regardless of the healthcare provider. Importantly, this provides assurance to potential patients that each of them will receive substantially the same minimum level of care regardless of the provider they select. Accordingly, rather than viewing the disclosed principles as providing an automated system or method for providing the features disclosed herein, the disclosed principles should be viewed as providing a system for determining or “learning” uniform or standardized practices based on gathered data, and providing of such determined uniform information for all similarly situated patients, which is not possible across a large range of medical providers without the disclosed system. Such a unique approach allows not only the same healthcare provider to provide a consistent level of service to all of his or her similarly situated patients, but also allows multiple healthcare providers to provide such consistent level of service across any number of similarly situated patients, as well as ensuring that the provided uniform information is determined from a broad collection of information from both physicians and databases accessed by the system. Therefore, by providing the dynamic list of questions consistent with the predetermined best practices for any given diagnosis and treatment, healthcare providers can also be assured that they are providing such consistent level of care to all of their patients.

Another advantage provided by the disclosed principles is that since the dynamic list of questions are standardized, the questions may be presented to patients by other personnel associated with the healthcare provider. For example, a medical assistant or nurse working with the healthcare provider's office is able to administer the questions since the questions are not only standardized for all patients, but are also written in accordance with best practices within each medical field. Accordingly, the person administering the questions to patients need not be especially skilled in medicine because the questions have already been created by skilled healthcare professionals and because the responses elicited direct the next question(s) to be presented. Such a unique approach provided by the disclosed principles allows for more efficient use of the physician's or other healthcare professional's time. Moreover, because the dynamic questions are predetermined based on the best practices for a particular medical field or industry, healthcare providers can ensure compliance with minimum requirements instituted by insurance companies, Medicare, or any other agency taken into consideration and “learned” by the disclosed system.

In addition to the standardized questions, a system or method in accordance with the disclosed principles further provides assistance to healthcare providers by assisting in diagnosing the current medical condition of the patient, as well as the likelihood the patient may be develop a medical condition in the future. Specifically, as the dynamic list of questions elicit responses that are used to target the patient's medical issue(s), the information not only dynamically alters the next questions presented, but also is used by the disclosed system to diagnose that condition or issue, or the likelihood of a condition or issue in the future. Thus, based on the information elicited by a system as disclosed herein, the disclosed system also is configured to provide the physician or other healthcare provider potential diagnoses for the particular patient. In this regard, the disclosed system is configured to access a database of medical information, and that information is used to present potential diagnoses to a physician employing the system. This is provided by the machine learning capabilities of the disclosed system, which “learns” to recognize such condition or issue based on previously gathered information from other physician users having similarly situation patients, as well as other sources of medical information accessed by the system. Once again, the compiled information allows the disclosed system to diagnose medical issues in accordance with the best practices of a particular medical field. As a result, the disclosed system assists physicians in more consistently, and correctly, diagnosing the current or future medical issues of their similarly situated patients. Also as before, the disclosed principles allow multiple healthcare providers to provide such consistent level of service across any number of similarly situated patients.

Moreover, a system according to the disclosed principles can even assist physicians in diagnosing conditions they are unfamiliar with. For example, in a situation where a new disease outbreak has occurred, many physicians may not have seen the disease before or may be confused by the symptoms associated by the new disease. However, the disclosed system is consistently updated with current medical information, as well as information from prior member physician experiences. Such updated information can assist an unknowing or confused physician in properly diagnosing the new disease. Similarly, as the system is updated with patient information where other patients have had very similar symptoms, the disclosed system can help the physician properly identify the patient's condition based on the collection of similar patient symptoms and other information provided by the disclosed symptom.

Still further, a system or method in accordance with the disclosed principles may further provide treatment options for a physician to prescribe to his or her patients. As the disclosed system employs the information elicited by the dynamic questioning of the patient to provide potential diagnoses for each particular patient, the disclosed system can further suggest treatment options that are also in accordance with the best practices for the determined diagnoses. In situations where just a single diagnosis is provided for a given set of patient responses, a single treatment option may be provided to the physician, and that treatment option would be in accordance with the best practices in that particular field given that particular set of elicited information. In other cases, multiple potential diagnoses may be provided to the physician, and the physician would use his or her best judgment to select one of those diagnoses. In some embodiments, the multiple diagnoses may be provided along with a probability of past correctness for each diagnosis, which may assist the physician in deciding which diagnosis he or she believes is correct. Similarly, if multiple treatment options are presented to the physician, whether for a current or onsetting condition, each of which may be in accordance with best practices for a particular medical field, the physician may use his or her judgment in selecting one of those treatment options. Once again, in some embodiments, the treatment options may each be provided with a percentage or other indicator indicating to what extent each treatment option is employed by other physicians so that information can be considered by the physician when making the decision on which treatment option to choose. In other embodiments, if insurance companies or other similar agency or organization only provides coverage for a certain treatment option, the disclosed system may also indicate that to the physician, which again may help the physician select a treatment option appropriate for a particular patient. The system is configured to check a patient's eligibility for each treatment option or procedure in real-time as well. This will insure that the physician will not unknowingly render services for which he or she will not be reimbursed.

For the information used by the disclosed system to determine potential diagnoses and to present potential treatment options based on those diagnoses, the disclosed principles also provide for a feedback system from users of the system. More specifically, information gathered from patients is used to continuously update the system, which in turn learns from this provided feedback what are the best practices under a given set of medical facts. In addition, a system in accordance with the disclosed principles is capable of evolving with current medical standards, and thus the disclosed system may be constantly updated with the most current medical information as that knowledge is discovered. Similarly, information on treatment options selected by physicians, as well as the success or failure of selected treatment options, is also used to continuously update the system. As a result, each new use of the system for a patient includes the most current information on both medical diagnoses and treatment options, which allows physicians the ability to provide medical services to their patients using the most up-to-date information for both medical resources and results from other physicians.

In some embodiments, a system as disclosed herein may also be used as an informational tool for patients. In many cases, as physicians learn what medical condition or issues a certain patient has or will likely develop in the future based on the patient's current habits, etc., the patient may wish to learn more about that condition as well. In conventional practice, a physician must maintain literature on numerous medical conditions that he or she may pass on to a patient seeking to learn about the condition. With a system in accordance with the disclosed principles, the physician need not personally maintain that information in order to provide it to interested patients. Instead, the disclosed system may include such information in the form of textual information, audio recording, or even video recordings. In such embodiments, as the system is used by the physician to diagnose a patient's current or likely future condition, the physician can also immediately provide information on the diagnosis to the patient in form of a video or audio recording, or simply a textual display for the patient to read at that moment. Similarly, a system as disclosed herein may also include similar information on the treatment options that may be available to a particular patient. In such embodiments, information on the available treatment options can not only help a physician choose a particular option, but may also help the patient understand what is involved in a particular treatment option, and thus whether he or she would like to try, or pass on, a particular treatment option. Still further, the disclosed system may also provide patient resources that assist the patient in following the selected treatment option, and such resources may be provided upon each follow-up visit or even through direct access by the patient while he or she is following a particular treatment plan.

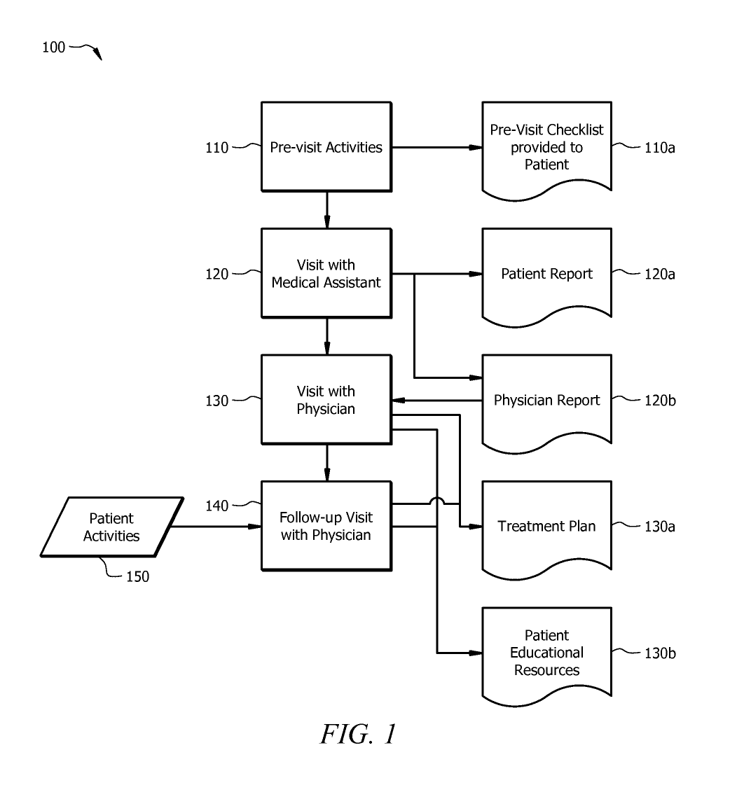

FIG. 1 illustrates a flow diagram 100 demonstrating exemplary activities that may take place within a system or method implemented in accordance with the disclosed principles. In such an exemplary process, a system as disclosed herein can provide medical staff with pre-visit activities in an initial Step 110. In this regard, the disclosed system can develop and customize pre-visit checklists 110a to provide to patients in order to ensure that the patient comes to the office visit with all the relevant information needed for the visit. With the checklist, the patient can then conduct whatever pre-visit activities are needed, such as gathering health history information, prescription medication usage information, etc. in order to be prepared for the visit to the physician. The pre-visit checklist may include a paper version of the questionnaire or a link to an online version of the questionnaire that the patient can fill out at home or elsewhere via a patient portal. If the patient did not fill out the questionnaire at home, they may be asked to fill it out while waiting to see the medical assistant, for example using a paper questionnaire or even a patient client terminal with an electronic questionnaire. This reduces the amount of time the medical office will need to spend acquiring the data in cases where patient did not complete a questionnaire prior to going to the visit.

After identifying and checking-in the patient, the patient's first encounter may be with the appropriately trained medical assistant or other staff at a Step 120. If a patient has not yet filled out a questionnaire, the disclosed system may then guide the medical assistant through the encounter by collecting information prompted by the dynamic questions of the questionnaire provided by the system. Where some patient information was previously obtained, the medical assistant only needs to collect information that was not previously supplied by the patient. The information gathered is then used by the system to provide one or more likely diagnoses of the patient's condition or issue, or to guide the physician in his or her diagnosis of the patient, whether it is a current condition or the likelihood that the patient may develop a condition in the future. In addition, by employing evidence-based guidelines, the disclosed system may be used to identify patients that need to have and/or are eligible for preventative services, screenings, or other evaluations or procedures. For example, rules implemented by the disclosed system may support the Accountable Care Organization Quality Performance Standards and meet and/or exceed the goals for Medicare Wellness Visits and Initial Preventive Physical Exam. This is especially useful in preventative care identification and mitigation situations for patients.

Once the medical assistant's use of the questionnaire of the disclosed system during the patient's visit is complete, the system may generate a Patient Report 120a for the physician. This report 120a may identify patient-specific guidelines that need to be addressed during the visit with the physician at a Step 130. For example, if the patient is on Medicare, the disclosed system will assist the physician in satisfying any required screenings, assessments, etc. required for Medicare coverage. Moreover, such guidelines may be provided to the physician in priority order as determined by current practice guidelines. As a result, the disclosed system ensures that the physician will always know what the recommended activities, etc. for a particular patient, during a particular visit, should be. For example, in some cases there may be more required activities, screenings, etc. than cannot be completed in a single visit. In those cases, the physician will be prompted to schedule additional visits to ensure that everything that is required for compliance with whichever guidelines are implicated are followed. Moreover, the system checks the patient's eligibility for each treatment option or procedure in real-time. This will insure that the physician will not unknowingly render services for which he or she will not be reimbursed. By presenting the physician with a comprehensive prioritized list based on appropriate guidelines for each particular patient, the disclosed system ensures that the physician follows all requirements during a visit, and thus important screenings etc. are not overlooked. Moreover, by prompting the physician of such guidelines and requirements in real time, proper reimbursement for the physician's services is also assured.

Once the physician has complied with any such requirements and once all of the patient's relevant health information is provided to the system, the disclosed system can assist the physician in making the appropriate diagnosis of the patient's medical situation, as discussed in detail above. Importantly, this diagnosis may be for an existing medical condition, or it may be a diagnosis that a patient will likely develop a future condition based on his or her current health and lifestyle. Such diagnosis may be included in the Physician Report 120b provided to the physician. The disclosed system may also makes treatment suggestions to the physician based on best practices in the pertinent medical field and present those to the physician via the Physician's report 120b. After considering suggestions provided by the system, as well as information regarding the individual treatment options, for example, based on prior physicians' experiences, the physician can then determine the best Treatment Plan 130a for the patient. As before, if Medicare or another similar agency's guidelines are implicated in the patient's treatment, then the disclosed system can guide the physician in ensuring compliance with any such guidelines. Then, once the physician and patient have completed all the activities, requirements, etc. for the visit, the system can also submit a bill in real-time that is fully compliant with insurers' requirements. No additional activities are required on the part of the physician or billing staff.

Once a Treatment Plan 130a has been established and relayed to the patient, the disclosed system can also notify the physician of any patient adherence issues that may be identified, for example, at a later follow-up visit, at a Step 140, and additional questioning regarding the Treatment Plan 130a. In this respect, the disclosed system can guide the conversation with the patient through the process of identifying and overcoming any barriers to patient compliance, and can even provide recommendations on how the physician can encourage their patients' compliance with a Treatment Plan 130a, and thus take responsibility for their own health. For example, for some chronic diseases or conditions, the disclosed system facilitates the physician's working with the patient to develop a jointly agreed upon lifestyle intervention Treatment Plan 130a customized to the patient's needs, ability and willingness to change. The disclosed system can even generate customized plans based on a patient's specific situation, which can be automatically updated until the desired results are achieved. For ongoing treatment plans, the system can even provide ongoing interaction with patients via a patient portal accessible by the patient. Furthermore, the physician can use the disclosed system to generate assessment reports, progress reports, etc. based on reported Patient Activities, at Step 150, during their following of a treatment plans, as well as Educational Material 130b related to the visit, the diagnosis, and to the treatment options selected for the patient.

Still further, a system in accordance with the disclosed principles may also allow a physician to incorporate population management into his or her practice without adding too much complexity. More specifically, whenever a quality performance metrics needs to be addressed, the disclosed system can be configured to display not only the information on the patient in the visit, but also to display the physician's overall record regarding this particular measure. By alerting physicians to the effectiveness of their treatment plans at the time when they are in the best position to address the issue, physicians will be better able to improve their overall performance, in addition to improving their performance in treating individual patients. By providing physicians this additional tool, a system in accordance with the disclosed principles ensures physician compliance with any of a number of incorporated regulations, such as the new “meaningful use” regulations implemented by Center for Medicare and Medicaid Services (CMS), as well as the Physician Quality Reporting System (PQRS) reporting requirements employed by Accountable Care Organizations (ACOs).

In some specific embodiments, the disclosed system is also beneficial for ensuring compliance with, and tracking results for, treatment plans for chronic conditions/diseases, such as obesity and diabetes. Of course, compliance can also be tracked for preventive treatment plans to help ensure patients do not develop such conditions. For example, many health plans allow patients up to 40 visits for counseling and behavioral therapy in their first year of diagnosis and treatment. With a system as disclosed herein, physicians are provided the resources to provide these services, while complying with any specific plan requirements, as well as to track patients' progress throughout the treatment plan. For example, the disclosed system may alert the physician to each recommended preventive service and be prompted to schedule it. Educational Materials 130b, such as the exemplary materials discussed above, may also be provided with the disclosed system so that physicians can provide a more customized counseling session for such patients, as well as to engage them in a discussion on any issues they need to address during the treatment plan. Examples of these Educational Materials 130b may include video, audio, or textual presentations regarding their specific condition(s), or perhaps the specific treatment plan selected for them by their physician. Of course, any type of material that may be helpful to educate a patient on their condition(s) or treatment(s), such as insurance or Medicare/Medicaid compliance requirements, or any other aspect of their medical status, may also be provided via such Material 130b.

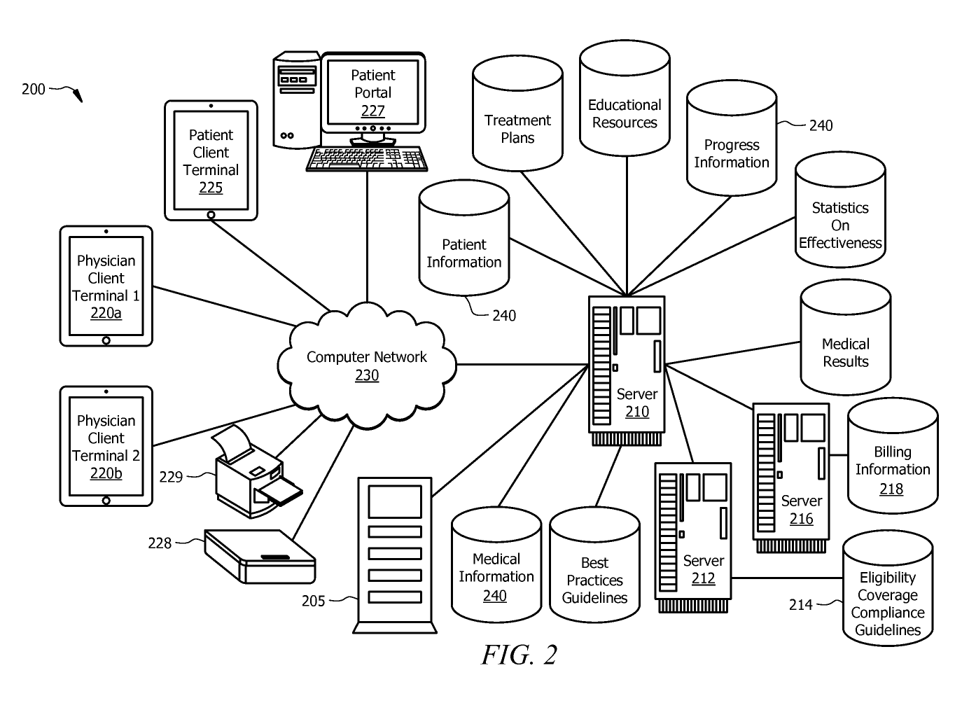

FIG. 2 illustrates an exemplary embodiment of a computer-implemented system 200 in accordance with the disclosed principles. In such an exemplary system 200, the disclosed principles may be implemented using a central computer 205 in a server-client relationship with other components of the system 200. More specifically, a centralized computer 205 provides control for the transfer of information throughout the system 200, as well as the processing of information for implementing the features of the system 200 discussed above.

In addition, one or more servers 210 and associated computing software and hardware can be configured to provide the communications for the system 200 in order to execute the disclosed principles. In addition, the one or more servers 210 may be configured to communicate across a communications network 230, such as a computer network, data network, or telecommunications network. Alternatively, the centralized computer 205 and the server 210 may be embodied in the same device, in which case the single device provides both the processing power and the communications needed to implement the system 200. In some embodiments, the network 230 may be the Internet. Moreover, the network 230 may be limited to a local network, or may include communication with a local network, such as a network within a single office or wide enough to encompass a large facility, such as a hospital, or even a large geographical area comprising multiple locations interconnected within the disclosed system 200. Accordingly, although FIG. 2 illustrates a single “network 230,” it should be understood that this is for simplicity, and thus distinct offices, hospitals, etc. subscribing to the system 200 may each include their own local network configured to facilitate communication between individuals at each such location and the larger system 200.

Across the network 230 from the centralized computer 205 and the server(s) 210 providing the communications may be one or more physicians' offices, or any other type of medical or healthcare provider that may benefit from a system as disclosed herein. Within those locations are one or more computing devices 220a, 220b (collectively 220), wherein each device comprises a client terminal 220 having a software client installed thereon. For example, computing tablets, as illustrated, may be employed; however, the software client of the disclosed principles may also be employed with other types of computing devices, such as notebook computers, desktop computers, and even mobile telephones. In short, the disclosed systems and methods may be implemented with any type of computing device, either now existing or later developed.

In operation, in one embodiment the network-connected server 210 provides communication between the central computer 205 and the physician client terminals 220 using the illustrated network 230. Moreover, communication may be wireless or hard-wired, and may also include the use of one or more local area networks at specific provider locations, such as at a hospital or an office with multiple physicians. Alternatively, as mentioned above, the disclosed system 200 may employ a single device to provide the functions of the central computer 205 and the one or more servers 210 to communicate with the client terminals 220. Also, rather than employing the central computer 205, in some embodiments the processing power of the system 200 is embodied in the client terminal(s) 220. In such embodiments, the central computer 205 may not be employed, and instead the disclosed system would function as disclosed herein using communication between such client terminal(s) 220 and communication server(s) 210.

The server(s) 210 may be configured to access one or more data sources (collectively 240) on behalf of the central computer 205 or the client terminal(s) 220, depending on the embodiment of the system, for both storing and gathering information used to implement the disclosed principles. For example, a database of patient information may be maintained that not only includes the standardized patient questions for the questionnaire, but also identification information on patients as well as anonymous medical-specific information, such as patients' conditions, symptoms, etc., which can then be used in conjunction with other similar medical information to assist in future diagnoses or other beneficial uses. In large-scale embodiments of the system 220, which may be as large as a global system, multiple central computers 205 and/or multiple servers 210 may be employed. Still further, multiple local servers may be used to implement the system 200, for example, with one or more servers assisting with communication to and from the data stores 240 (including a dedicated server for each data store) and the central computer 205, as well as one or more servers assisting with communication to and from the client terminals 220. Moreover, the various data stores 240 may be located in different locations, and related data stores may be located together at one location, while unrelated data stores may be located at other locations. However, no limitation to the grouping or location of the data stores 240 that may be implemented with the disclosed system 200 should be implied.

The questions provided by the system 200, which are discussed in detail above, can be downloaded to the client terminals 220, either as they are presented to a patient or in totality ahead of the patient interview process. Moreover, as illustrated, the system 200 may include patient client terminals 225 for use by patients to respond to the questionnaire. For example, when a patient visits a physician's office, the patient can be given a patient terminal 225 which they can use for the questionnaire. Such embodiments would further reduce the time needed for office personnel to spend with patient gathering information for use with the disclosed principles of the system 200. In other embodiments, patients could be given access to a patient portal 227, for example, for accessing via their home computer. Such a patient portal 227 is interconnected to the system 200 using a communications network 230, and may thus be used by the patient to take the questionnaire for the disclosed system 200, as well as to provide any other patient information that may be used by the system 200. Again, such embodiments help reduce the amount of time needed for office personnel to spend with patients in gathering needed information. Still further, a paper version of the questionnaire may also be created for patients to respond to at home or at the physician's office, and the response to such questionnaire may be provided to the system 200 via a scanner such as the scanner 228 illustrated in FIG. 2. Of course, even in such paper-based embodiments, the questions in the questionnaire would be specifically tailored to patients, for example, based on the type of visit scheduled, and thus more than one paper questionnaire may be employed in such embodiments. Thus, multiple paper questionnaires may be needed through the information gathering process. Whether the questionnaire is presented to patients via physician terminals, patient terminals, or even a patient portal, the information for the questionnaire is provided by the system in the manner discussed in detail below.

To generate the appropriate questions for a particular patient, the central computer 205 (or the client terminal(s) 220 in embodiments not employing a central computer 205) in the disclosed system 200 may access one or more databases 240 having the standardized questions, or such standardized questions may simply be stored locally in the central computer 205 or in the client terminal 220. In addition, the system 200 may also employ a number of varying databases 240 or other types of data stores having information that assist in specific question selection by the system 200. For example, the central computer 205 or client terminals 220 may employ the server 210 to access, either ahead of time or in real-time, data regarding the best practices for a given medical field. Such information is used to guide the questions to be asked of the patient, as well as suggested diagnoses and/or potential treatment options, and thus ensure the best practices are employed uniformly for all patients. More specifically, this is provided by the system employing machine learning to compile data provided from any number of sources, such as medical information databases and prior physician use of the system, and then “learn” the best practices for diagnosing and treating a medical condition under each particular set of medical facts. General medical information, such as information on available medicines, known illnesses and diseases, or other useful medical knowledge may be accessed by the system 200 to obtain the most up-to-date known medical data. For example, the system 200 can detect a sudden rise in a particular symptom in a specific geographic area and alert the physician that although this condition may seem rare it is happening all around them and may warrant closer attention. These models also allow the system 200 to identify outliers. For example, the system 200 can detect physicians who are significantly out performing their peers and those who are significantly under performing their peers. Analysis of those who are doing well will help improve the “best practices” models, while those who are underperforming will be alerted to what they can do to improve. These models are also used to predict the probability of success of treatment options etc.

Eligibility and coverage compliance information may also be accessed by the disclosed system 200. For example, requirements established by Medicare and/or Medicaid (e.g., through CMS) or even private insurance companies are accessed by the disclosed system 200 to ensure that the physician complies with coverage and eligibility requirements, as well as requirements that must be followed for proper reimbursement from such agencies. Specifically, the disclosed principle allow healthcare practitioners to determine eligibility/coverage for procedures or treatments as physicians selected such options presented by the system 200. Moreover, the disclosed principles can provide such real-time determinations in multiple ways, such as the system 200 presenting treatment options or procedures to physicians that have already been vetted for eligibility/coverage, or determining such eligibility/coverage in real-time as the physician make his or her selection, which may then in turn cause the physician to alter such selection.

The databases associated with compliance or eligibility requirements for certain treatment plans may be accessed by the system 200 using a server 212 maintained by the appropriate agency or insurance company. The actual rules or other guidelines, as well as other appropriate information or records, maintained by the agency may be stored in their private data store 214, and the system 200 may interact with the agency via its server(s) 212 in order to determine any eligibility or coverage requirements for a particular patient's situation. Similarly, patient billing may also be provided by the system 200 through communication with a payment provider, such as an insurance company or even a governmental agency. The system 200 may communicate with such a payment provider via their own server 216, which may be in real-time, e.g., as discussed above for treatment eligibility, as the patient is finishing his visit with a physician employing the system 200. Billing information, such as payment records or medical billing codes may be stored in the payment provider's own data store 218 as well, and such records may also be accessible by a user of the system 200.

In FIG. 2, while the independently maintained servers 212, 216 are shown connected to the server 210, such connection may be provided through a communications network as well, such as the Internet. Of course, these independent servers 212, 216 may be connected via any type of network connection with server 210, including through the illustrated network 230. Stated another way, the illustrated network 230 is may be embodied as an overall network, such as the Internet, through which some or all of the components of a system according to the disclosed principles may be interconnected and communicate. Also, multiple networks, whether public or private, and whether local or wide in nature, may be employed to facilitate interconnection and communication for some or all of the components of a system according to the disclosed principles.

Once a patient has been properly interviewed in accordance with the questions determined by the system 200 and presented via the client terminals 220, the patient's responses and other gathered personal information may be used by the system 200 to create a patient record, as discussed above. In addition, based on the gathered information, treatment plan options may then be developed for the patient by the system 200. A plan database may be employed by the disclosed system 200 that includes generic plans for given patient situations, and may also include customized plans created for each patient. Such plans, once selected or created, may then also be stored in the treatment plans database. By storing selected treatment plans, the system 200 can later access information on such plans, such as which plans are most commonly employed for a given patient situation, or perhaps a customized plan for a later patient who is similarly situated. Such information may be used by the system 200 to inform other physicians, for example, who may not be familiar with all potential treatment options, or even to alleviate the need to re-create a customized plan that has already been created for a prior patient that is similarly situated. Again, this allows the disclosed system 200 to ensure more uniformity in physician care, regardless of location or experience, and importantly where that uniformity is in accordance with established best practices, whether local or universal.

To assist a patient with a selected treatment plan, or perhaps to assist in selecting a plan in the first place, educational resources/materials may also be selected and provided by the central computer 205 or client terminals 220 within the disclosed system 200. As discussed above, such material may include literature or audio/video presentations regarding specific conditions or specific treatment plans and how best to implement them. Such resources help patients implement a treatment plan, can explain the benefits of available treatment plans, and even any potential side effects of a particular plan or resulting from not following an implemented plan. Thus, such resources help ensure patient compliance with selected treatment plans, and may be provided on an ongoing basis with each patient visit. For paper-based materials, a printer 229 may be provided in the system, connected via the network 230, to print out materials for patient use. In other embodiments, electronic materials may alternatively be provided to patients and delivered, e.g., via the patient portal or other electronic means. Moreover, such a printer 229 may be employed to provide patient bills, records, or other materials related to the patient's visit, condition or treatment plan.

As a patient is placed on a particular treatment plan, the patient's progress on that plan may also be tracked and stored by the disclosed system 200, again using the central computer 205 or client terminals 220, with communications provided via the server 210. Such information may be stored in a separate progress information database, if desired. By storing such progress information separately, the disclosed system 200 may safely provide access to this information to patients, without risk of patients gaining access to unauthorized information. In addition, the disclosed system 200 may also include information on the patient's medical results or outcome, for example, as a result of following a particular treatment plan. As with other information, anonymous medical results information may also be used collectively by the system 200 to better understand and thereby learn the results of certain treatment plans, or other collective information that may be useful for future application by physicians or the disclosed system 200. Still further, the system 200 may generate and keep statistics on the effectiveness of particular treatment plans for use by users of the system 200. This information may be employed to assist physicians in selecting the best treatment options for their patients, even if they have little or no experience with certain treatment options.

It should be noted that although FIG. 2 illustrates a number of separate databases 240 for all of the exemplary information/data discussed above, a system 200 in accordance with the disclosed principles is not so limited. In other embodiments, the information in one or more of the illustrated databases 240 may be combined into a single database. Alternatively, the information may be divided into an even further number of databases than those illustrated. Furthermore, any one or more of such databases, or none of the databases, may be maintained by a system or entity external to, and thus independent from, the disclosed system 200. For example, while patient information, personalized treatment plans and progress information on a physician's patients may be kept in local databases due to their local nature, while statistics on effectiveness, educational resources and overall medical information may be stored in a global manner that is accessible by any number of physicians/offices that are subscribers to the disclosed system 200. Moreover, information determined independently from the system, such as best practices guidelines or billing/compliance coverage guidelines, may be independently stored and managed such that the central computer 205 or client terminal 220 simply accesses or otherwise receives such information from sources that are independent from the disclosed system 200 for the machine learning process to determine the best course of action regarding a particular set of medical facts. However, in other embodiments, all of the informational databases 240 may be maintained within the disclosed system 200, and information stored in each database 240 may be acquired by the central computer 205 or client terminal 220 from independent sources external to the system 200 as needed. In short, the disclosed principles are not limited to any particular architecture, structure, or type or number of devices, and instead the disclosed principles are broad enough to encompass any type of system configured to implement the teachings provided herein.

In sum, the disclosed principles allow any size medical practice, such as an individual primary care provider all the way up to nationwide hospital chain with thousands of affiliated physicians, to consistently and accurately treat their patients with uniform and best practices standard of care, and for both preventive and existing patient care. This is provided by the machine learning capabilities of a system implemented in accordance with the disclosed principles using a combination of prior physician input/experiences and obtained medical information and compliance guidelines to determine the best practices for a given set of medical facts. Likewise, the disclosed principles create patient confidence that they are receiving such a uniform level of care, regardless of the location, size or experience of the healthcare provider they select. Additionally, the disclosed principles streamline the patient interview process, and alleviates the requirement for the physician to personally conduct the entirety of the patient interview. In addition to a better use of the physician's time, the disclosed principles also ensure that physicians or their staff thoroughly and uniformly cover not only the patient's condition and diagnosis, but also the patient's treatment plan. This is especially beneficial for preventive care treatments, since all participating physicians would be provided information on more available treatment plans than they may or may not be familiar with, as well as the success and failures of previous plans and resources to assist patients with information on available treatment plans and ensure compliance with a selected plan. Moreover, for patient care involving tedious and strict guidelines, such as for Medicare compliance, the disclosed principles not only ensure physician/patient compliance with such guidelines, but also identifies opportunities for physicians to recover potentially lost revenues by identifying up-to-date eligible screenings and referrals that may otherwise be overlooked or that may be performed without proper compensation or reimbursement.

The previous descriptions, for the purposes of explanation, have been detailed with reference to specific embodiments of the invention. However, the illustrative details are not intended to be exhaustive or limit the invention in any way to only the details which have been disclosed. A myriad of changes, alterations, transformations, and modifications may be suggested to one skilled in the art, and it is intended that the present invention encompass such changes, alterations, transformations, and modifications as fall within the scope of the appended claims. The embodiments were selected and explained to best embody the principals of the invention and its practical applications, to thereby enable others skilled in the art to best utilize the invention and various embodiments with changes, alterations, transformations, and modifications as are suited to the particular use contemplated.

Moreover, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Detailed Description” any claims issuing from the subject matter taught in the present disclosure should not be limited by the language chosen under this heading to describe the so-called field. Further, a description of any technology as background or conventional is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method for providing standardization in medical diagnoses and treatments of patient medical conditions by physicians, the method comprising:
providing prior patient information comprising prior patient medical facts via client terminals to a learning computer;
obtaining, by the learning computer, medical information comprising medical conditions and treatments of medical conditions from one or more data sources;
compiling, by the learning computer, the patient information and the medical information to determine possible medical conditions of future patients and possible treatment options corresponding to the possible medical conditions;
administering a universal patient questionnaire to a new patient via a client terminal to gather new patient information, the questionnaire comprising standardized questions stored in a database associated with the learning computer, wherein questions presented in the questionnaire are dynamically selected based on responses by the new patient provided via the client terminal;
presenting, to the new patient's physician via the client terminal, one or more possible medical conditions of the new patient based on a set of medical facts derived from the new patient information, the one or more possible medical conditions selected from the possible medical conditions of future patients determined by the learning computer;
receiving, by the new patient's physician via the client terminal, a selection of a medical condition from the presented one or more possible medication conditions;
presenting, to the new patient's physician via the client terminal, one or more possible treatment options for the selected medical condition, the one or more possible treatment options selected from the possible treatment options corresponding to the possible medical conditions for future patients determined by the learning computer;
receiving, by the new patient's physician via the client terminal, a selection of a treatment option by from the presented one or more possible treatment options; and
storing, in the database, treatment results, provided by the new patient's physician via the client terminal, of the selected treatment option on the selected medical condition, the stored treatment results for use by the learning computer when compiling the patient information and the medical information to determine possible medical conditions of future patients and possible treatment options corresponding to the possible medical conditions.

2. A method according to claim 1, wherein presenting one or more possible treatment options comprises presenting a plurality of treatment options, the method further comprising presenting information on past results for each presented treatment option to the new patient's physician via the client terminal to aid the physician in selecting one of the plurality of treatment options.

3. A method according to claim 1, wherein storing treatment results further comprises storing feedback regarding the selected treatment option received from the new patient's physician via the client terminal, the stored feedback for use by the learning computer in determining possible medical conditions of future patients and possible treatment options corresponding to the possible medical conditions.

4. A method according to claim 3, further comprising presenting the stored feedback to another new patient's physician via another client terminal for use by the another physician in selecting a treatment option for the another new patient.

5. A method according to claim 1, wherein the dynamically selected questions are selected based on predetermined medical guidelines for diagnosis and treatment of a medical condition.

6. A method according to claim 5, wherein the predetermined guidelines are provided by a government healthcare agency.

7. A method according to claim 5, wherein the predetermined guidelines are provided by a healthcare insurance company.

8. A method according to claim 5, further comprising presenting one or more of the predetermined medical guidelines for the medical condition to the new patient's physician via the client terminal for use in selecting a medical condition or a treatment option.

9. A method according to claim 8, wherein the presented one or more predetermined guidelines comprise one or more medical screenings for the new patient.

10. A method according to claim 1, further comprising, in response to the treatment option selected by the new patient's physician, providing, by the client terminal, a source of educational materials regarding the selected treatment option for the new patient's use in following the selected treatment option.

11. A method according to claim 10, wherein the educational material comprises a video, audio, or textual presentation.

12. A method according to claim 1, wherein the database comprises a plurality of databases distinguished based on type of information stored in each of the plurality of databases.

13. A method according to claim 12, wherein at least one of the multiple databases is maintained independently from a system comprising the centralized computer and client terminals.

14. A system for providing standardization in medical diagnoses and treatments of patient medical conditions by physicians, the system comprising:
a learning computer in communication with a computer network and configured to:
obtain medical information comprising medical conditions and treatments of medical conditions from one or more data sources, and
compile the patient information and the medical information to determine possible medical conditions of future patients and possible treatment options corresponding to the possible medical conditions;
one or more client terminals configured to provide prior patient information comprising prior patient medical facts to the learning computer via the network; and
a universal patient questionnaire configured to be administered to a new patient via a client terminal to gather new patient information, the questionnaire comprising standardized questions stored in a database associated with the learning computer, wherein questions presented in the questionnaire are dynamically selected based on responses by a patient provided via a client terminal;
wherein the learning computer is further configured to:
present, to the new patient's physician via the client terminal, one or more possible medical conditions of the new patient based on a set of medical facts derived from the new patient information, the one or more possible medical conditions selected from the possible medical conditions of future patients determined by the learning computer;
receive, by the new patient's physician via the client terminal, a selection of a medical condition from the presented one or more possible medication conditions;
present, to the new patient's physician via the client terminal, one or more possible treatment options for the selected medical condition, the one or more possible treatment options selected from the possible treatment options corresponding to the possible medical conditions for future patients determined by the learning computer;
receive, by the new patient's physician via the client terminal, a selection of a treatment option by from the presented one or more possible treatment options; and
store, in the database, treatment results, provided by the new patient's physician via the client terminal, of the selected treatment option on the selected medical condition, the stored treatment results for use by the learning computer when compiling the patient information and the medical information to determine possible medical conditions of future patients and possible treatment options corresponding to the possible medical conditions.

15. A system according to claim 14, wherein the one or more treatment options comprise a plurality of treatment options, the learning computer further configured to present information on past results for each presented treatment option to the new patient's physician via the client terminal to aid the physician in selecting one of the plurality of treatment options.

16. A system according to claim 14, wherein the learning computer is further configured to store treatment results by receiving feedback regarding a selected treatment option from the new patient's physician via the client terminal for use by the learning computer in determining possible medical conditions of future patients and possible treatment options corresponding to the possible medical conditions.

17. A system according to claim 16, wherein the learning computer is further configured to present the stored feedback to another new patient's physician via another client terminal for use by the another physician in selecting a treatment option for the another new patient.

18. A system according to claim 14, wherein the dynamically selected questions are selected based on predetermined medical guidelines for diagnosis and treatment of a medical condition.

19. A system according to claim 18, wherein the predetermined guidelines are provided by a government healthcare agency.

20. A system according to claim 18, wherein the predetermined guidelines are provided by a healthcare insurance company.

21. A system according to claim 18, wherein the learning computer is further configured to present one or more of the predetermined medical guidelines for the medical condition to the new patient's physician via the client terminal for use in selecting a diagnosis or a treatment option.

22. A system according to claim 21, wherein the presented one or more predetermined guidelines comprise one or more medical screenings for the new patient.

23. A system according to claim 14, wherein the learning computer is further configured to, in response to the treatment option selected by the new patient's physician, provide via the client terminal a source of educational materials regarding the selected treatment option for new patient's use in following the selected treatment option.

24. A system according to claim 23, wherein the educational material comprises a video, audio, or textual presentation.

25. A system according to claim 14, wherein the database comprises a plurality of databases distinguished based on type of information stored in each of the plurality of databases.

26. A system according to claim 25, wherein at least one of the multiple databases is maintained independently from the system.
